(19) United States
(12) Patent Application Publication
(10) Pub. No.: US 2025/0268428 A1
(43) Pub. Date: Aug. 28, 2025

(54) SENSOR SOAP DISPENSER

(71) Applicant: Kraus USA Plumbing LLC, Port Washington, NY (US)

(72) Inventors: Serhiy Torak, Noblesville, IN (US); Todd Alexander, Hollis, NH (US)

(21) Appl. No.: 19/035,094

(22) Filed: Jan. 23, 2025

Related U.S. Application Data
(60) Provisional application No. 63/557,036, filed on Feb. 23, 2024.

(51) Int. Cl. A47K 5/12

(52) U.S. Cl. CPC A47K 5/1217; A47K 5/1211

(57) ABSTRACT

A soap dispenser including a dispensing spout configured to be supported above a mounting deck. A sensor is supported by the dispensing spout and is in electrical communication with a controller supported below the mounting deck. The controller includes a normal operating mode and an anti-clog operating mode.

### CROSS-REFERENCE TO RELATED APPLICATION

The present application claims priority to U.S. Provisional Patent Application Ser. No. 63/557,036, filed Feb. 23, 2024, the disclosure of which is expressly incorporated herein by reference.

### BACKGROUND AND SUMMARY OF THE DISCLOSURE

The present invention relates generally to a soap dispenser and, more particularly, to a sink deck mounted, electronic sensor soap dispenser including a below deck controller providing for normal and anti-clog modes of operation.

Electronic soap dispensers including sensors for hand-free operation are known in the art. Such electronic soap dispensers may include proximity sensors to detect the presence of a user and dispense soap in response thereto.

According to an illustrative embodiment of the present disclosure, a soap dispenser includes a dispensing spout configured to be supported above a mounting deck and including an outlet. A mounting shank is operably coupled to the dispensing spout and is configured to extend downwardly from the dispensing spout through the mounting deck. A soap reservoir is fluidly coupled to the dispensing spout and is configured to hold liquid soap below the mounting deck. A pump is fluidly coupled to the soap reservoir for pumping liquid soap to the outlet of the dispensing spout. The pump is configured to be supported below the mounting deck. A sensor is supported by the dispensing spout and is configured to provide an outlet signal when a user is within a detection area near the dispensing spout. A controller is in electrical communication with the sensor and is positioned below the mounting deck. The controller is configured to receive the output signal from the sensor and activate the pump to dispense liquid soap in response to the output signal.

According to a further illustrative embodiment of the present disclosure, a soap dispenser includes a dispensing spout configured to be supported above a mounting deck and including an outlet. A mounting shank is operably coupled to the dispensing spout and is configured to extend downwardly from the dispensing spout through the mounting deck. A soap reservoir is fluidly coupled to the dispensing spout and is configured to hold liquid soap below the mounting deck. A pump is fluidly coupled to the soap reservoir for pumping liquid soap to the outlet of the dispensing spout. A sensor is supported by the dispensing spout and is configured to provide an output signal when a user is within a detection area near the dispensing spout. A controller is in electrical communication with the sensor and is configured to receive the output signal from the sensor and activate the pump to dispense liquid soap in response to the output signal. The controller illustratively includes a normal operating mode and an anti-clog operating mode. The controller selecting one of the normal operating mode and the anti-clog operating mode based upon the position of the user within the detection area and the duration of the user within the detection area.

According to another illustrative embodiment of the present disclosure, a soap dispenser includes a dispensing spout configured to be supported above the mounting deck and including an outlet. A mounting shank is operably coupled to the dispensing spout and is configured to extend downwardly from the dispensing spout through the mounting deck. A soap reservoir is fluidly coupled to the dispensing spout and is configured to hold liquid soap below the mounting deck. A pump is fluidly coupled to the soap reservoir for pumping liquid soap to the outlet of the dispensing spout. A sensor is supported by the dispensing spout and is configured to provide an output signal when a user is within a detection area near the dispensing spout. A controller is in electrical communication with the sensor and is configured to receive the output signal from the sensor and to activate the pump to dispense liquid soap in response to the output signal. The controller includes a normal operating mode and an anti-clog operating mode. The controller selects the operating mode based upon the position of the user within the detection area and the duration of the user within the detection area. The detection area includes a first detection limit and a second detection limit, the second detection limit being closer to the sensor then the first detection limit. The first detection limit defines a normal operating mode and the second detection limit defines the anti-clog operating mode. When the controller is in the normal operating mode, it will cause the pump to dispense liquid soap for a first duration. When the controller is in the anti-clog operating mode, it will cause the pump to dispense liquid soap for a second duration, the second duration being greater than the first duration.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

A detailed description of the drawings particularly refers to the accompanying figures, in which:

FIG. 1 is a front perspective view of an illustrative sensor soap dispenser of the present disclosure shown mounted on a sink deck adjacent to a kitchen faucet;

FIG. 2 is a rear perspective view of the illustrative sensor soap dispenser of FIG. 1;

FIG. 3 is a front perspective view of the dispensing spout of the illustrative sensor soap dispenser of FIG. 1;

FIG. 4 is a front exploded perspective view of the dispensing spout of FIG. 3;

FIG. 5 is a rear exploded perspective view of the dispensing spout of FIG. 3;

FIG. 6 is a block diagram of components of the illustrative sensor soap dispenser of FIG. 1;

FIG. 7 is a side elevational view of the illustrative sensor soap dispenser of FIG. 1, showing a normal mode of operation;

FIG. 8 is a side elevational view of the illustrative sensor soap dispenser of FIG. 7, showing an anti-clog mode of operation;

FIG. 9 is a perspective view of the illustrative sensor soap dispenser of FIG. 3, showing a soap reservoir refill operation; and

FIG. 10 is a detailed perspective view showing coupling of the dispensing spout and the mounting shank of the sensor soap dispenser of FIG. 9.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

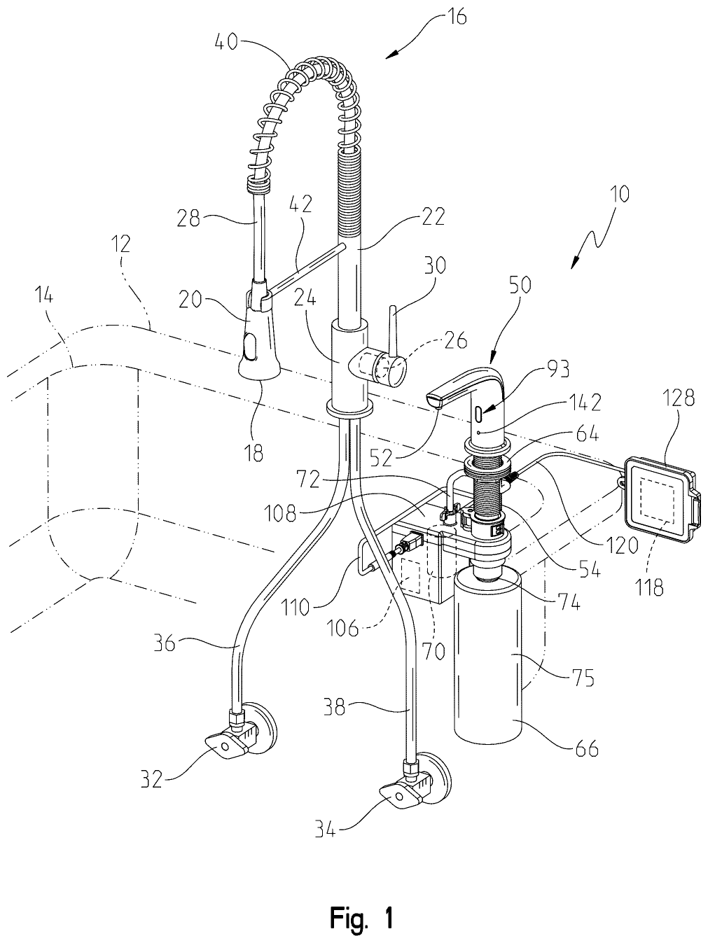

Referring initially to FIG. 1, an illustrative electronic soap dispenser 10 is shown coupled to a mounting or sink deck 12 defining a sink basin 14 and positioned adjacent to a conventional kitchen faucet 16. The kitchen faucet 16 illustratively includes a water outlet 18 to dispense water into the sink basin 14. The water outlet 18 is illustratively defined by a sprayhead 20 supported by a spout 22. The spout 22 may be supported for swiveling movement by a hub 24. The water outlet 18 is in fluid communication with a conventional mixing valve 26 via an outlet tube 28 and controlled via a input or control handle 30. Water is supplied to the mixing valve 26 via a hot water source (e.g., hot water stop) 32 and a cold water source (e.g., cold water stop) 34 via a hot water inlet line 36 and cold water inlet line 38, respectively.

The spout 22 of the illustrative kitchen faucet 16 is a spring spout including a spring 40 receiving the outlet tube 28. An arm 42 releasably couples the sprayhead 20 to the spout 22. While the illustrative kitchen faucet 16 is a spring spout faucet, other types of faucets may be substituted therefor.

The soap dispenser 10 illustratively includes a dispensing head or spout 50 supported above the mounting deck 12 and including a liquid soap outlet 52. A mounting shank 54 illustratively extends downwardly from the dispensing spout 50 through the mounting deck 12.

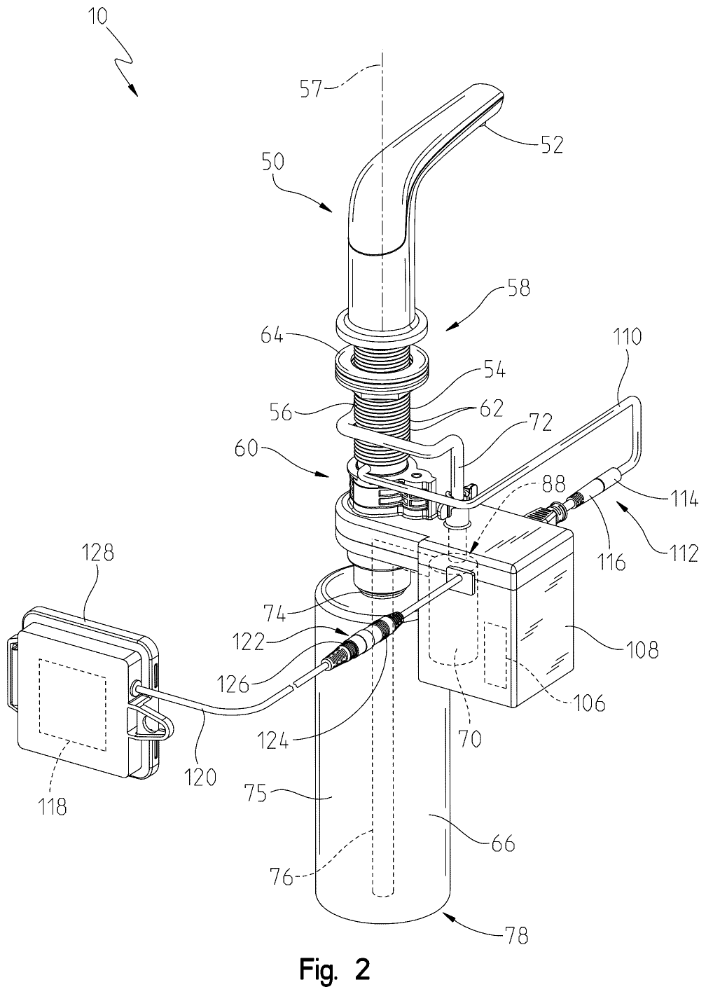

With reference to FIGS. 1 and 2, the illustrative mounting shank 54 is a hollow tubular member including a cylindrical side wall 56 extending vertically along a longitudinal axis 57 between a first, upper end 58 and a second, lower end 60. The side wall 56 includes external threads 62. A threaded nut 64 is configured to cooperate with the external threads 62 of the mounting shank 54 to couple the dispensing spout 50 to the mounting deck 12.

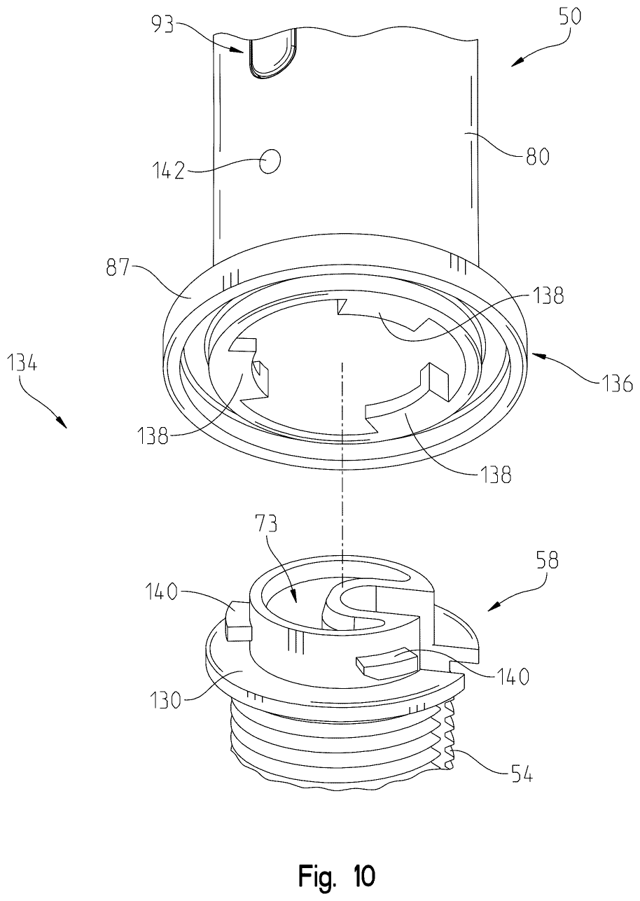

A liquid soap reservoir 66 is operably coupled to the dispensing spout 50 via the mounting shank 54. A pump 70 is configured to pull liquid soap from the soap reservoir 66 to the outlet 52 of the dispensing spout 50. More particularly, an outlet tube 72 couples the pump 70 to the outlet 52. A soap refill passageway 73 extends within the mounting shank 54 from the upper end 58 axially downwardly to the reservoir 66 (FIG. 10). The reservoir 66 is illustratively defined by a plastic container 75 including an open upper end 74 in fluid communication with the lower end 60 of the mounting shank 54. A supply tube 76 illustratively extends between the pump 70 and a lower end 78 of the soap reservoir 66.

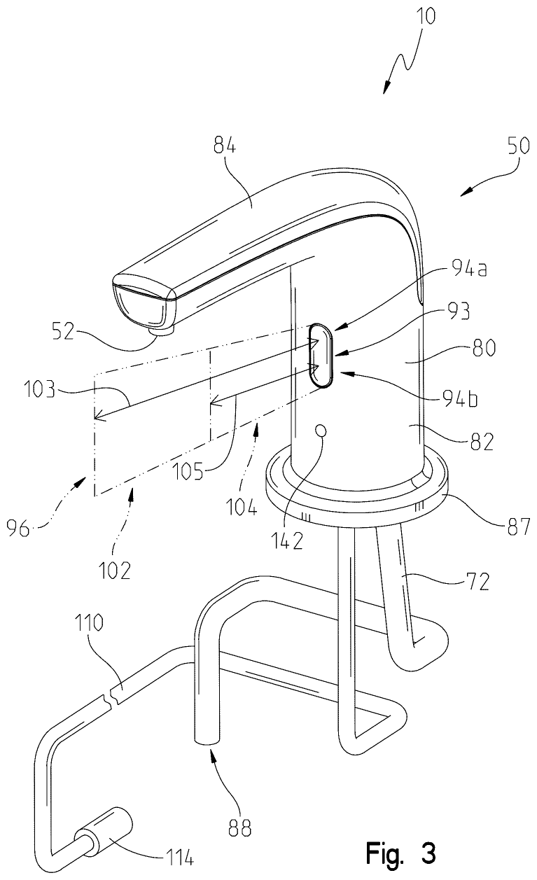

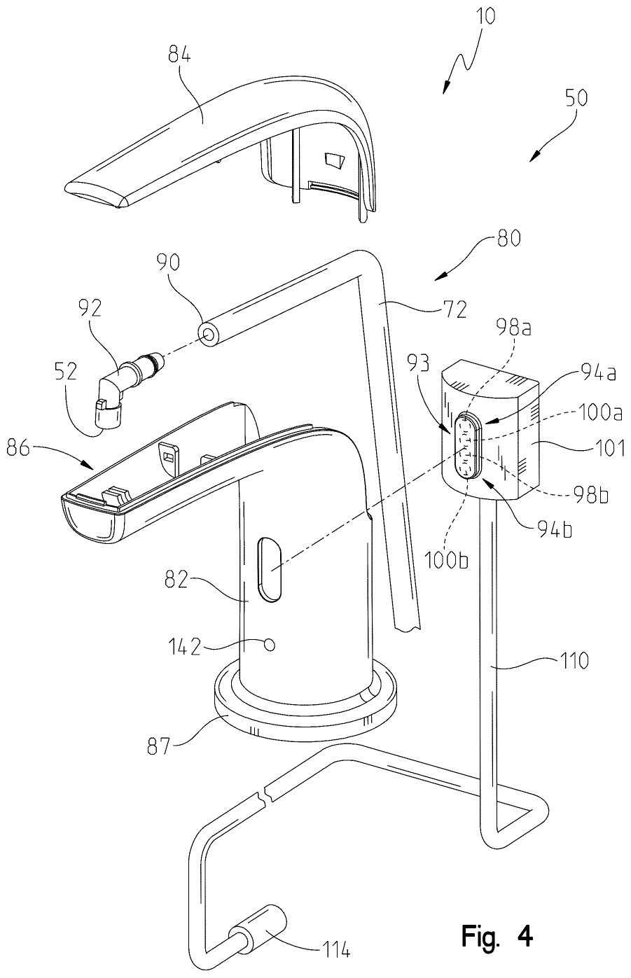

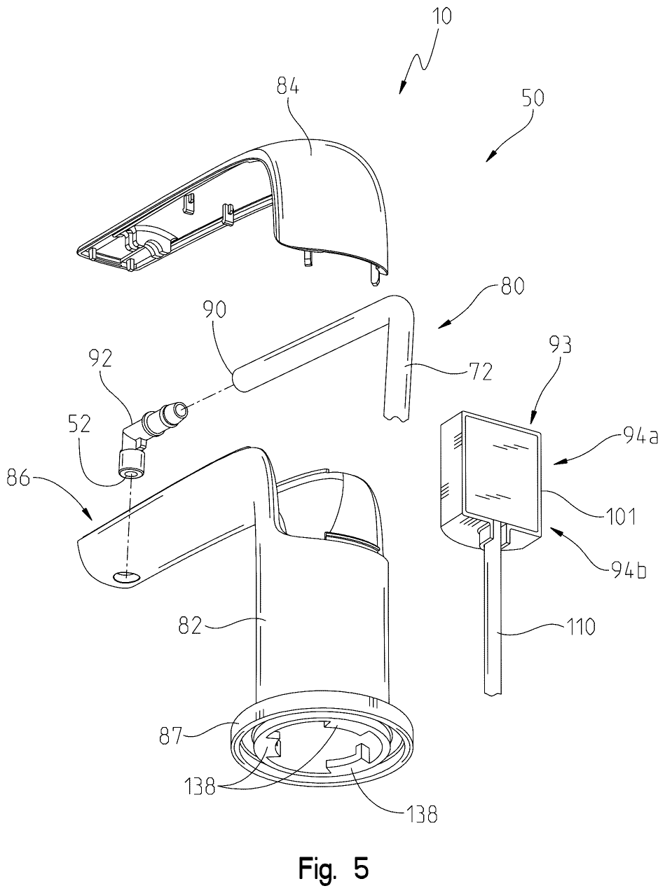

With reference to FIGS. 3-5, the illustrative dispensing spout 50 includes a body 80 having a first or lower shell 82 and a second or upper shell 84 defining a passageway 86 receiving a portion of the outlet tube 72. The lower shell 82 illustratively includes a mounting flange 87. The outlet tube 72 illustratively extends between a first end 88 and a second end 90. The first end 88 is fluidly coupled to the pump 70, while the second end 90 is fluidly coupled to a nozzle 92 defining the soap outlet 52 (FIGS. 2 and 4). As shown in FIGS. 1, 2 and 9, the outlet tube 72 extends upwardly from the pump 70 external to the mounting shank 54, then through the sidewall 56 of the mounting shank 54, through the upper end 58 of the mounting shank 54 and within the passageway 86 of the dispensing spout 50.

A proximity sensor 93 is supported by the dispensing spout 50 and is configured to provide an output signal when a user is within a detection area or zone 96 near the dispensing spout 50. Illustratively, the proximity sensor 93 may comprise a first or long-range infrared (IR) sensor 94a, and a second or near-range infrared (IR) sensor 94b. Each infrared sensor 94a, 94b illustratively includes an emitter 98a, 98b to emit infrared light, and a receiver 100a, 100b configured to receive reflected infrared light from the emitter 98a, 98b. The emitter 98a, 98b and the receiver 100a, 100b are received within a housing 101. The infrared sensors 94a, 94b of the proximity sensor 93 may determine distance and duration of a user (e.g., hands) within the detection area 96.

While a pair of infrared sensors 94a, 94b are illustrated, it may be appreciated that the proximity sensor 93 may be defined by any number of infrared sensors (e.g., a single infrared sensor). Alternatively, other types of proximity sensors (e.g., inductive, capacitive, ultrasonic, etc.) may be substituted therefor.

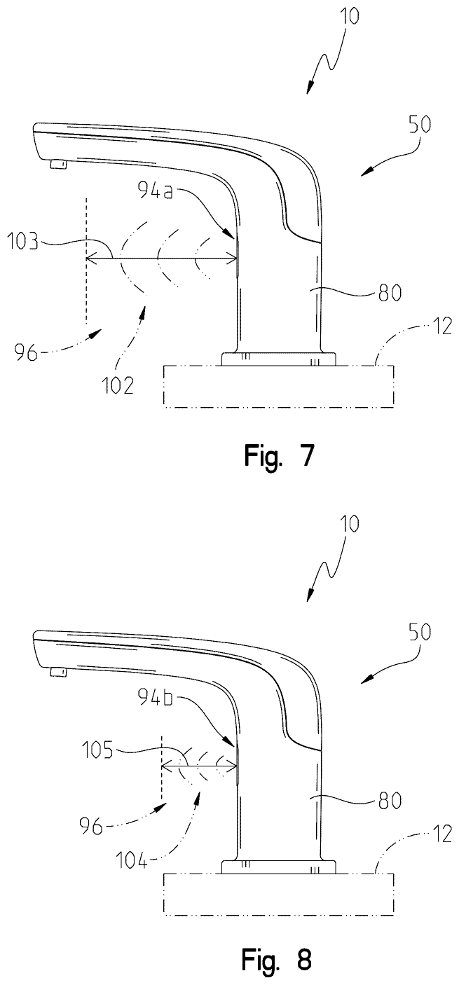

The detection area 96 illustratively includes a first detection zone or limit 102 and a second detection zone or limit 104. Illustratively, the first detection zone 102 is further from the dispensing spout 50 (and hence the proximity sensor 93) than the second detection zone 104 (FIGS. 3, 7 and 8). More particularly, the first detection zone 102 extends a first distance 103 from the proximity sensor 93, and the second detection zone 104 extends a second distance 105 from the proximity sensor 93. As further detailed herein, the first distance 103 is greater than the second distance 105.

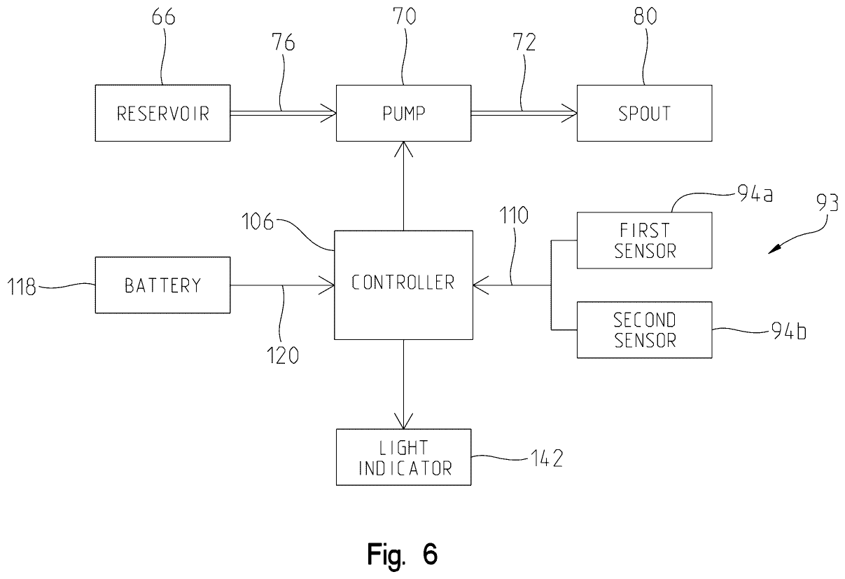

With reference to FIGS. 2 and 6, a controller 106 is in electrical communication with the sensor 93 and is configured to receive the output signal from the infrared sensors 94a, 94b and activate the pump 70 to dispense liquid soap in response to the output signal. Illustratively, both the controller 106 and the pump 70 are located within a control box 108 positioned below the sink deck 12. An electrical cable 110 provides an electrical connection between the sensor 94 and the controller 106. A quick release coupler 112 (such as a socket 114 and a plug 116) may be provided in the cable 110 to assist in installation and servicing.

Illustratively, a battery 118 is also supported below the sink deck 12 and is in electrical communication with the controller 106 via an electrical cable 120. A quick release coupler 122 (such as a socket 124 and a plug 126) may be provided in the cable 120 to assist in installation and servicing. The battery 118 may include batteries (e.g., four AA batteries) received within a battery box 128.

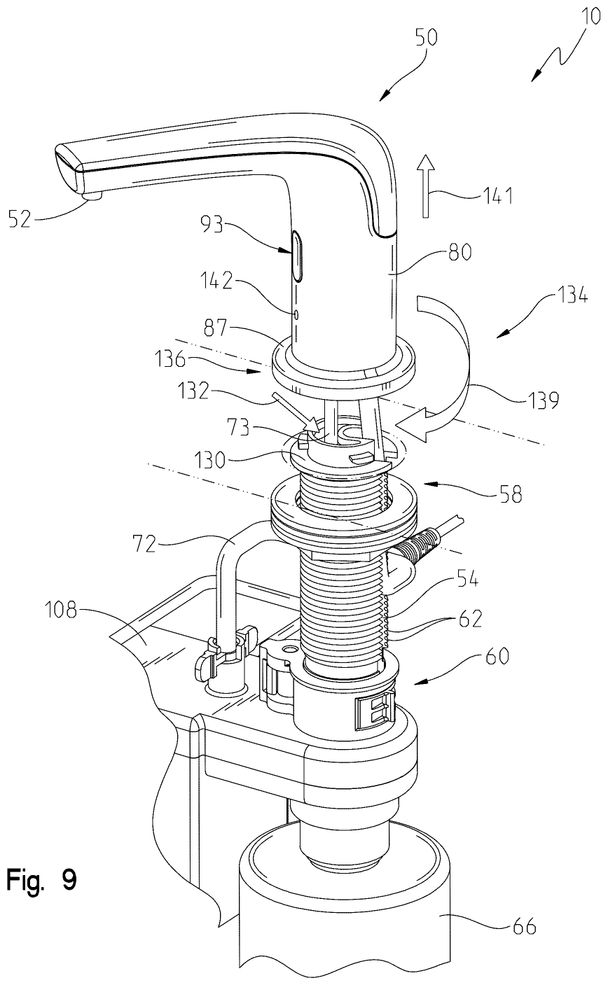

With reference to FIGS. 9 and 10, a mount 130 is supported by the upper end 58 of the mounting shank 54 and defines the soap refill passageway 73 (for supplying liquid soap to the reservoir 48 as shown by arrow 132 in FIG. 9). A releasable coupler 134 is defined between a lower end 136 of the dispensing spout 50 and the upper end 58 of the mounting shank 54. Illustratively, the coupler 134 includes first tabs 138 on the dispensing spout 50, and cooperating second tabs 140 on the mounting shank 54. The tabs 138 and 140 define a bayonet type coupler to couple the dispensing spout 50 to the mounting shank 54. A user may access the soap refill passageway 73 by rotating the spout 50 (as shown by arrow 139) and then axially lifting the spout 50 vertically (as shown by arrow 141).

A light indicator 142 is illustratively supported by the dispensing spout 50 and is in electrical communication with the controller 106. The electrical cable 110 may provide an electrical connection between the light indicator 142 and the controller 106. The light indicator 142 may comprise a light emitting diode (LED) and is configured to provide an indication of the operating mode of the controller 106. The light indicator 142 may also provide an indication of other operating conditions, such as low battery power, low liquid soap in the reservoir 66 and/or service required.

With further reference to FIGS. 3, 7 and 8, the detection area 96 includes the first detection zone or limit 102 and the second detection zone or limit 104. The second detection zone 104 is closer to the sensor 93 supported by the dispensing spout 50 than the first detection zone 102. Illustratively, distance 103 of the first detection zone 102 is approximately 3 inches +/−0.45 inches from the sensor 93, and the distance 105 of the second detection zone 104 is approximately 1 inch +/−0.45 inches from the sensor 93. The first detection zone 102 defines a normal operating mode, and the second detection zone 104 defines an anti-clog operating mode.

In the illustrative normal operating mode, when the first infrared sensor 94a detects a user's hands within the first detection zone 102 for a first predetermined sensing time period (approximately 0.25 seconds), then the output signal from the sensor 94a will cause the controller 106 to operate the pump 70 for dispensing liquid soap for a first duration or predetermined dispensing time period (approximately 3 seconds) until activated again.

In the illustrative anti-clog operating mode, when the second infrared sensor 94b detects a user's hands within the second detection zone 104 for a second predetermined sensing time period (approximately 5 seconds), then the output signal from the sensor 94b will cause the controller 106 to operate the pump 70 for dispensing liquid soap for a second duration or predetermined dispensing time period (approximately 10 seconds). This extended dispensing time helps prevent liquid soap from being blocked in the outlet tube 72. During dispensing in the anti-clog operating mode, the light indicator 142 will illustratively flash (illustratively 0.3 seconds every 1 second) as a mode indication to the user.

Although the invention has been described in detail with reference to certain preferred embodiments, variations and modifications exist within the spirit and scope of the invention as described and defined in the following claims.

1. A soap dispenser comprising:
a dispensing spout configured to be supported above a mounting deck and including an outlet;
a mounting shank operably coupled to the dispensing spout and configured to extend downwardly from the dispensing spout through the mounting deck;
a soap reservoir fluidly coupled to the dispensing spout and configured to hold liquid soap below the mounting deck;
a pump fluidly coupled to the soap reservoir for pumping liquid soap to the outlet of the dispensing spout, the pump configured to be supported below the mounting deck;
a sensor supported by the dispensing spout and configured to provide an output signal when a user is within a detection area near the dispensing spout; and
a controller in electrical communication with the sensor and positioned below the mounting deck, the controller configured to receive the output signal from the sensor and to activate the pump to dispense liquid soap in response to the output signal.

2. The soap dispenser of claim 1, further comprising:
a soap supply tube external to the mounting shank and fluidly coupled between the pump and the dispensing spout; and
a soap refill passageway defined within the mounting shank and including an inlet positioned above the mounting deck and an outlet positioned below the inlet and in fluid communication with the soap reservoir.

3. The soap dispenser of claim 2, further comprising:
a mount supported by the mounting shank and defining the inlet; and
a releasable coupler defined between a lower end of the dispensing spout and the mount of the mounting shank.

4. The soap dispenser of claim 1, further comprising a battery in electrical communication with the controller and configured to be supported below the mounting deck.

5. The soap dispenser of claim 1, further comprising a light indicator supported by the dispensing spout and in electrical communication with the controller.

6. The soap dispenser of claim 1, wherein the sensor is an infrared sensor including an emitter and a receiver.

7. The soap dispenser of claim 1, wherein the controller includes a normal operating mode and an anti-clog operating mode, the controller selecting the operating mode based upon the position of the user within the detection area and the duration of the user within the detection area.

8. The soap dispenser of claim 7, wherein the detection area includes a first detection zone and a second detection zone, the second detection zone closer to the sensor than the first detection zone, the first detection zone defining the normal operating mode and the second detection zone defining the anti-clog operating mode.

9. The soap dispenser of claim 8, wherein the first detection zone is defined by a long-range infrared sensor, and the second dictation zone is defined by a near-range infrared sensor.

10. The soap dispenser of claim 7, wherein:
the controller in the normal operating mode will cause the pump to dispense liquid soap for a first duration;
the controller in the anti-clog operating mode will cause the pump to dispense liquid soap for a second duration; and
the second duration is greater than the first duration.

11. The soap dispenser of claim 1, wherein the pump and the controller are received within a control box under the mounting deck.

12. A soap dispenser comprising:
a dispensing spout configured to be supported above a mounting deck and including an outlet;
a soap reservoir fluidly coupled to the dispensing spout and configured to hold liquid soap;
a pump fluidly coupled to the soap reservoir for pumping liquid soap to the outlet of the dispensing spout;
a sensor supported by the dispensing spout and configured to provide an output signal when a user is within a detection area near the dispensing spout;
a controller in electrical communication with the sensor, the controller configured to receive the output signal from the sensor and to activate the pump to dispense liquid soap in response to the output signal; and
wherein the controller includes a normal operating mode and an anti-clog operating mode, the controller selecting one of the normal operating mode and the anti-clog operating mode based upon the position of the user within the detection area and the duration of the user within the detection area.

13. The soap dispenser of claim 12, wherein the detection area includes a first detection zone and a second detection zone, the second detection zone closer to the sensor than the first detection zone, the first detection zone defining the normal operating mode and the second detection zone defining the anti-clog operating mode.

14. The soap dispenser of claim 13, wherein the first detection zone is defined by a long-range infrared sensor, and the second dictation zone is defined by a near-range infrared sensor.

15. The soap dispenser of claim 12, wherein:
the controller in the normal operating mode will cause the pump to dispense liquid soap for a first duration;
the controller in the anti-clog operating mode will cause the pump to dispense liquid soap for a second duration; and
the second duration is greater than the first duration.

16. The soap dispenser of claim 12, further comprising:
a mounting shank operably coupled to the dispensing spout;
a soap supply tube external to the mounting shank and fluidly coupled between the pump and the dispensing spout; and
a soap refill passageway defined within the mounting shank and including an inlet positioned above the mounting deck and an outlet positioned below the inlet and in fluid communication with the soap reservoir.

17. The soap dispenser of claim 12, further comprising a light indicator supported by the dispensing spout and in electrical communication with the controller, the light indicator configured to provide an indication of the operating mode of the controller.

18. The soap dispenser of claim 12, wherein the sensor is an infrared sensor including an emitter and a receiver.

19. A soap dispenser comprising:
a dispensing spout configured to be supported above a mounting deck and including an outlet;
a mounting shank operably coupled to the dispensing spout and configured to extend downwardly from the dispensing spout through the mounting deck;
a soap reservoir fluidly coupled to the dispensing spout and configured to hold liquid soap below the mounting deck;
a pump fluidly coupled to the soap reservoir for pumping liquid soap to the outlet of the dispensing spout;
a sensor supported by the dispensing spout and configured to provide an output signal when a user is within a detection area near the dispensing spout;
a controller in electrical communication with the sensor, the controller configured to receive the output signal from the sensor and to activate the pump to dispense liquid soap in response to the output signal;
wherein the controller includes a normal operating mode and an anti-clog operating mode, the controller selecting the operating mode based upon the position of the user within the detection area and the duration of the user within the detection area;
wherein the detection area includes a first detection limit and a second detection limit, the second detection limit closer to the sensor than the first detection limit, the first detection limit defining the normal operating mode and the second detection limit defining the anti-clog operating mode;
wherein the controller in the normal operating mode will cause the pump to dispense liquid soap for a first duration; and
wherein the controller in the anti-clog operating mode will cause the pump to dispense liquid soap for a second duration, the second duration being greater than the first duration.

20. The soap dispenser of claim 19, further comprising:
a soap supply tube external to the mounting shank and fluidly coupled between the pump and the dispensing spout; and
a soap refill passageway defined within the mounting shank and including an inlet positioned above the mounting deck and an outlet positioned below the inlet and in fluid communication with the soap reservoir.

21. The soap dispenser of claim 20, further comprising:
a mount supported by the mounting shank and defining the inlet; and
a releasable coupler defined between a lower end of the dispensing spout and the mount of the mounting shank.

22. The soap dispenser of claim 19, further comprising a light indicator supported by the dispensing spout and in electrical communication with the controller, the light indicator configured to provide an indication of the operating mode of the controller.

23. The soap dispenser of claim 19, wherein the sensor is an infrared sensor including an emitter and a receiver.

24. The soap dispenser of claim 19, wherein the first detection limit is defined by a long-range infrared sensor, and the second dictation limit is defined by a near-range infrared sensor.
